(19) United States
(12) Patent Application Publication
(10) Pub. No.: US 2023/0065902 A1
(43) Pub. Date: Mar. 2, 2023

(54) INTENTION-DRIVEN INTERACTIVE FORM-FILLING METHOD FOR DIKW COTENT

(71) Applicant: HAINAN UNIVERSITY, Haikou (CN)

(72) Inventors: YUCONG DUAN, Haikou (CN); Yue HUANG, Haikou (CN)

(21) Appl. No.: 17/564,266

(22) Filed: Dec. 29, 2021

Related U.S. Application Data
(63) Continuation of application No. PCT/CN2021/127300, filed on Oct. 29, 2021.

(30) Foreign Application Priority Data
Sep. 1, 2021 (CN) 202111022025.8

(51) Int. Cl. G06F 40/174; G06N 5/02

(52) U.S. Cl. CPC G06F 40/174; G06N 5/022

(57) ABSTRACT

An intention-driven interactive form-filling method for DIKW contents includes the following steps: constructing a first DIKP model according to information of a person that fills in a form, and constructing a second DIKP model according to the information of the form; performing intention comparison and value determination according to the first DIKP model and the second DIKP model, to obtain a filling value level of the form; performing form information filling by using a reducing certainty method, a fuzzy transmission method and a defense filling method, according to different filling value levels; and performing feedback verification on the form information that has been completely filled in. The present disclosure combines an DIKP system with an automatic form filling system to fill in information automatically, which can save a process of filling in the information manually and realize the intellectualization of filling in the form, and in the filling process, intention of the preparer is fully considered, so that the filled information will not violate the intention of the preparer and protect privacy of the preparer.

### BACKGROUND

### 1. Technical Field

The present disclosure generally relates to the field of information processing technologies, and especially relates to an intention-driven interactive form-filling method for DIKW contents.

### 2. Description of Related Art

With the development of information and data in today's world, a variety of forms are emerging in an endless stream. For example, it needs to fill in a takeout form to order a meal, fill in a ticket form to buy a high-speed train ticket, fill in questionnaires for a variety of apps and websites, and for a business trip or leave, etc. These problems can be classified as content filling. When there are many contents to be filled in, a person that fills in the form will encounter common problems such as repeated filling, filling errors, too much troubles, and information disclosure and so on. For form-based applications, the most tedious work is to fill in many fields of the form. The content filled in by users is often repetitive, and some fields are operated in a plurality of steps only to obtain the same option value.

Most conventional automatic filling technologies are limited to the extent of data or information migration, and then the data that has been sorted is basically filled in by matching key values, data items in Excel forms are automatically filled in into a single Excel/Word form one by one, a piece of data is entered so as to automatically generate a complete set of contracts in batches, which does not intelligently reflect on how to fill in the content; in addition, intention of a preparer is not considered in the filling process, which can lead to filling behaviors contrary to the intention of the preparer; similarly, there is no intention to determine and analyze the form, and it does not consider whether such filling can bring adverse consequences to the preparer.

Everyone has his/her own data, information, knowledge and wisdom, which represents his/her own cognition and understanding of external objective things, a DIKW (data, information, knowledge and wisdom) atlas system can be obtained by modeling the data, the information, the knowledge and the wisdom, the DIKW atlas is a relatively new atlas model in data processing at present. A DIKP (data, information, knowledge and purpose) atlas system can be obtained by combining the DIKW atlas with personal intention, and data in the DIKP atlas system can be configured for storage, transmission and calculation; however, there is no relevant literature to provide the DIKP atlas system for intelligently filling in forms to solve problems of tediously filling in the forms, incorrectly filling in contents, and non-considering intention of the preparer in a filling process thereof.

### SUMMARY

The technical problems to be solved: in view of the shortcomings of the related art, the present disclosure relates to an intention-driven interactive form-filling method for DIKW contents which can fully consider the intention of the preparer and the intention of the form, and use intention-driven to solve various problems in the filling process, so as to realize intellectualization and improve rationality thereof.

The technical solution adopted for solving technical problems of the present disclosure is:

an intention-driven interactive form-filling method for DIKW contents according to an embodiment of the present disclosure includes the following steps:

step S1, constructing a first DIKP model according to information of a person that fills in a form, and constructing a second DIKP model according to the information of the form;

step S2, performing intention comparison and value determination according to the first DIKP model and the second DIKP model, to obtain a filling value level of the form;

step S3, performing form information filling by using a reducing certainty method, a fuzzy transmission method and a defense filling method, according to different filling value levels, and

step S4, performing feedback verification on the form information that has been completely filled in.

Preferably, the step of constructing the first DIKP model in the step S1, includes: determining whether a previous DIKP model of a preparer exists in a system, if the previous DIKP model of the preparer does not exist in the system, constructing the first DIKP model according to data and intention currently input by the preparer, if the previous DIKP model of the preparer exists in the system, supplementing and updating the previous DIKP model by using the data and the intention currently input, to obtain the first DIKP model.

Preferably, the second DIKP model in the step S1 is configured to obtain intention of the whole form and each form item according to a form category, an internal form item, a position relationship, a topological structure and alternative items, so as to construct the second DIKP model.

Preferably, specific steps of the step S2 are: comparing the intention of the form and the intention of the preparer, determining a difference between the intention of the form and the intention of the preparer through semantic analysis and DIKP model comparison, determining whether the form that has been filled in generates an income according to the intention of the preparer, and determining a filling value level of the form according to the difference and whether the difference is occurred.

Preferably, the filling value level includes three levels: a high level, a common level and a low level; if there is a little difference between the intention of the form and the intention of the preparer, and it can be determined that the income is brought to the preparer according to the intention of the preparer, that is, the filling value level is the high level; if there is a little difference between the intention of the form and the intention of the preparer, and it is difficult to determine whether the income is brought to the preparer according to the intention of the preparer, that is, the filling value level is the common level; and if the intention of the form is quite different from the intention of the preparer, that is, the filling value level is the low level.

Preferably, when the filling value level is determined to be the high level, the reducing certainty method is used to fill in the form information, specific steps include:

step S311, obtaining first data of a preparer in the first DIKP model;

step S312, obtaining a plurality of form items associated with the first data from the form of the second DIKP model;

step S313, for the plurality of form items that has been associated with each other in the step S312, traversing the first DIKP model, and finding information associated with the first data according to a mapping relationship thereof; and

step S314, filling the first data into a corresponding form item according to the information associated with the first data.

Preferably, when the filling value level is determined to be the common level, the fuzzy transmission method is used to fill in the form information, specific steps include: obtaining second data of the preparer in the first DIKP model, and filling the second data into the form by cutting off an inclusion relationship, a cascade relationship, a partial order relationship or a fuzzy change mode among the data, the information and knowledge.

Preferably, the fuzzy change mode includes: transforming a deterministic type to a probabilistic type, transforming an independent type to a comparative type, transforming a global type to a local type, and transforming a numerical type to a range type.

Preferably, when the filling value level is determined to be the low level, the defense filling method is used to fill in the form information and includes non-filling and filling in the form by using the fuzzy transmission method.

Preferably, specific steps of the step S4 includes:

step S41, traversing the first DIKP model and the second DIKP model to determine whether the content that has been filled in conforms to intention of the person that fills in the form; and

step S42, when the content that has been filled in does not satisfy the intention of the person that fills in the form, changing the content that does not conform to the intention by an intention coverage mode or a fuzzy change mode.

The present disclosure provides the advantages as below.

The present disclosure provides an intention-driven interactive form-filling method for DIKW contents, and constructs the DIKP model for the preparer and the form, wherein the DIKP model includes the data, the information, the knowledge and the intention of the preparer and the form, performing intention comparison and value determination according to the two DIKP models, to obtain the filling value level of the form; performing form information filling by using the reducing certainty method, the fuzzy transmission method and the defense filling method, according to different filling value levels; and performing feedback verification on the form information that has been completely filled in. By combining the DIKP system with automatic form filling, the intention of the preparer and the intention of the form are fully considered, so as to realize intellectualization and rationalization of filling in the form.

### BRIEF DESCRIPTION OF THE DRAWINGS

In order to more clearly understand the technical solution hereinafter in embodiments of the present disclosure, a brief description to the drawings used in detailed description of embodiments hereinafter is provided thereof. Obviously, the drawings described below are some embodiments of the present disclosure, for one of ordinary skill in the related art, other drawings can be obtained according to the drawings below on the premise of no creative work.

FIG. 1 is a flowchart of an intention-driven interactive form-filling method for DIKW contents in accordance with an embodiment of the present disclosure.

FIG. 2 is a flowchart of filling in form information by a reducing certainty method of the intention-driven interactive form-filling method for DIKW contents of FIG. 1.

FIG. 3 is a flowchart of performing feedback verification on the form information that has been completely filled in of the intention-driven interactive form-filling method for DIKW contents of FIG. 1.

### DETAILED DESCRIPTION

Reference will now be made in detail to embodiments, examples of which are illustrated in the accompanying drawings. In the following detailed description, numerous specific details are set forth in order to provide a thorough understanding of the subject matter presented herein.

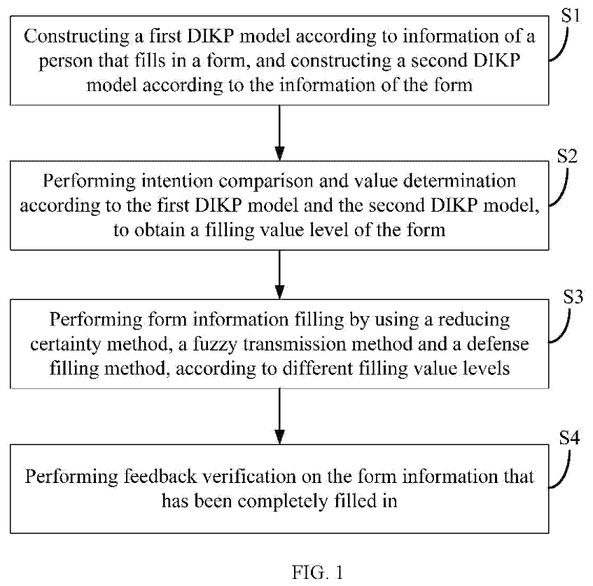

Referring to FIG. 1 to FIG. 3, an intention-driven interactive form-filling method for DIKW contents according to an embodiment of the present disclosure, includes the following steps:

step S1, constructing a first DIKP model according to information of a person that fills in a form, and constructing a second DIKP model according to the information of the form.

The DIKP model includes a data system, an information system, a knowledge system and an intention system. Data in the data system is a discrete element that has been obtained by direct implementation, which does not reflect specific meaning without contexts, and will generate information when the data in the data system is combined with a specific intention; the information in the information system is a combination of the data and the intention, which is a response to the data according to the specific intention and is a directional expression. A plurality of intentions can be related to the data or the information, and concept transformation from a data type to an information type can be implemented by connecting target data with at least one intention. The intention is an implicit or explicit purpose or goal of human beings related to specific things. In the data, the information and the knowledge, the intention is mainly associated with the data, and a single data or a plurality of data can be combined with one or more intentions. Main relationships between the intentions themselves are: and or, not, and including, an intention can be divided into several sub-intentions. Knowledge is obtained by structured and formal statistics, derivation and deduction of the data and the information, and further condensed on the basis of information to form a knowledge rule, which reflects certain regularity, has certain stability and reusability; the data, the information and the knowledge can be combined and transformed with each other.

Preferably, the step of constructing the first DIKP model in the step S1, includes: determining whether a previous DIKP model of the preparer exists in a system, if the previous DIKP model of the preparer does not exist in the system, constructing the first DIKP model according to data and intention currently input by the preparer; if the previous DIKP model of the preparer exists in the system, supplementing and updating the previous DIKP model by using the data and the intention currently input, to obtain the first DIKP model. The second DIKP model in the step S1 is configured to obtain intention of the whole form and each form item according to a form category, an internal form item, a position relationship, a topological structure and alternative items, so as to construct the second DIKP model.

When solving practical problems, the data, the intentions, the information and the knowledge are often insufficient, incomplete and inaccurate, in this case, it is more necessary to establish a system to verify and supplement each other. For the first DIKP model of the preparer, previous DIKP models are constructed or updated according to the data and the intention that have been currently input by the preparer, and the data system and the intention system are established according to the data and the intention of the preparer himself. Combining the data system with the intention system, the information system is established through “D+P=I”, and then the knowledge system is constructed, the data, the intention, the information and the knowledge have an inclusion relationship, an inheritance relationship and other relationships. With the establishment or supplement of the system, a cascade relationship and a topological structure can be further generated. Finally, the system is stored in the form of an atlas mode, so as to obtain the first DIKP model. A construction process of the second DIKP model is similar to that of the first DIKP model. After a second DIKP system is constructed, the second DIKP system can be configured to analyze differences between the intentions of the preparer and whether an adverse impact is occurred on the preparer, so as to perform value determination.

Both the first DIKP model and the second DIKP model have the same internal framework of the DIKP system. In the DIKP system: 1) the number of edges from an initial node to a target node is called as a distance, and the number of nodes is called as a depth; 2) a structure is consisted by some nodes and the edges; 3) the edge output from the node is called as an output edge, also known as a branch, and the number of the output edges is called an output degree of the node; the edge entering the node is called as an input edge, and the number of the input edges is called as an input degree of the node; 4) the distance and the depth from the initial node to the target node represent a cognitive distance, a sum of all nodes in the depth is called as a deviation coefficient, if the cognitive distance is too long and the deviation coefficient is too high, a cost of finding the target node will be too high, but a target accuracy thereof can be increased; 5) a sum of the output degree of the node and the output degree of its corresponding sub-node is called as a probability deviation factor of the node, the larger the probability deviation factor is, the lower the accuracy of the target node is. 6) other nodes that arrive from a node through the output edge are called as the sub-nodes of the node, and the nodes that can reach through the output edge of the sub-node and the output edge at a next lower level of the sub-node are called as a unicorn node of the node; 7) if a parent node has only one output edge to reach the sub-node, and the sub-node has only one input edge, that is, the output degree of the parent node is 1, and the input degree of the sub-node is 1, which is called a cascade relationship therebetween; 8) if the output degree of the parent node is 1, the output degree of the sub-node is less than or equal to 1, and the depth of the sub-node exceeds 2, it is called a partial order relationship mode, and such kind of structure is called as a partial order structure; 9) if the two structures are compared with each other, their initial nodes are the same, and if a certain number of sub-nodes or unicom nodes with the depth of 3 are the same, the difference therebetween is small; otherwise, the difference is large; 10) the nodes of an I system can be combinatory mapped by the nodes of a D system and the nodes of a P system, and the nodes of a K system can be combinatory mapped by the nodes of the D system, the nodes of the I system, and the nodes of the P system.

Step S2, the step of performing intention comparison and value determination according to the first DIKP model and the second DIKP model, to obtain the filling value level of the form, includes the following specific steps: comparing the intention of the form and the intention of the preparer, determining a difference between the intention of the form and the intention of the preparer through semantic analysis and DIKP model comparison, determining whether the form that has been filled in generates an income according to the intention of the preparer, and determining the filling value level of the form according to the difference and whether the difference is occurred. The filling value level includes three levels: a high level, a common level and a low level; if there is a little difference between the intention of the form and the intention of the preparer, and it can be determined that the income is brought to the preparer according to the intention of the preparer, that is, the filling value level is the high level; if there is a little difference between the intention of the form and the intention of the preparer, and it is difficult to determine whether the income is brought to the preparer according to the intention of the preparer, that is, the filling value level is the common level; and if the intention of the form is quite different from the intention of the preparer, that is, the filling value level is the low level.

For example, when Tom fills in an enterprise recruitment form, in the first DIKP model of Tom, Tom's intention was to join the company, and the intention of the form is to recruit new employees, through performing semantic analysis and model comparison, it is found that the difference between Tom's intention and the intention of the form is small, and an income can be determined according to Tom's intention—filling in the form is Tom's entry way, so the form is marked as “a high filling value level”; when filling in a form item of visual acuity in physical conditions of the form, if it is found that Tom has mild myopia by traversing The first DIKP model of Tom, and according to analyze the second DIKP model of the form, it is found that the intention of the form item is to recruit the job does not recruit employees with myopia, which is very different from Tom's intention, then the form item is recorded as “a low filling value level”.

Step S3, after obtaining the filling value level of the form, different methods are used to fill in the form information according to the filling value level; when the filling value level is determined to be the high level, the reducing certainty method is used to fill in the form information; when the filling value level is determined to be the common level, the fuzzy transmission method is used to fill in the form information; and when the filling value level is determined to be the low level, the defense filling method is used to fill in the form information.

After performing the intention comparison and the value determination, the form item with the high filling value level needs to be filled in; however, when the data, the information and the knowledge are insufficient, incomplete and inaccurate, the flow of the data and the information in the process of filling in contents has a kind of location uncertainty, the data can be combined with a plurality of intentions, and the information that has been obtained is relatively divergent, so that the location filled in by the data and the information can also be divergent, which is called as the location uncertainty. Such location uncertainty is difficult to be eliminated because the data, the information and the knowledge are insufficient, incomplete and inaccurate. However, the uncertainty can be reduced by traversing the first DIKP model of the preparer, finding all possible relevant nodes, and then adding relevant data, information or knowledge to nodes of the content that need to be filled in according to the mapping relationship between the nodes of cross-systems.

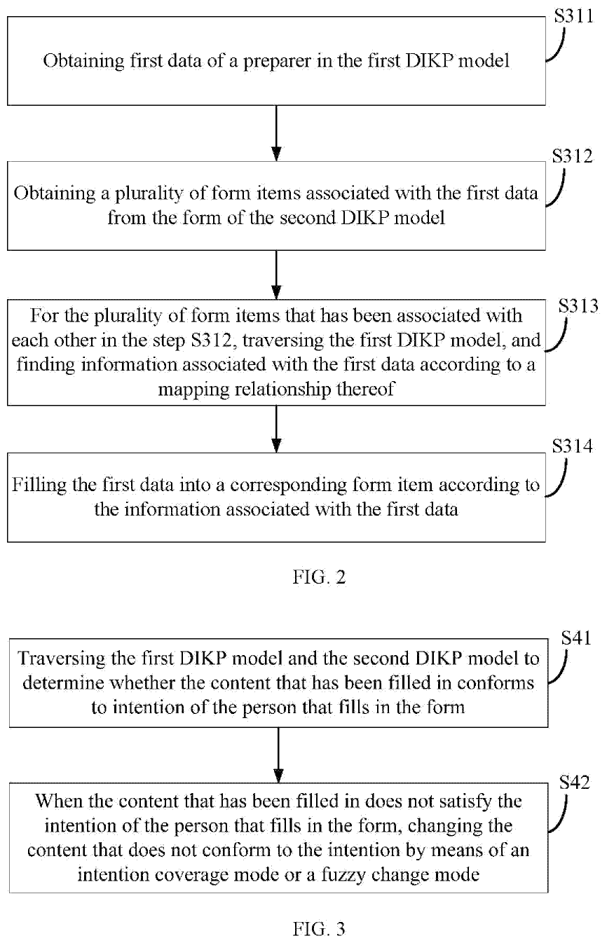

Referring to FIG. 2, the specific steps of filling in the form information by using the reducing certainty method, include:

step S311, obtaining first data of the preparer in the first DIKP model;

step S312, obtaining a plurality of form items associated with the first data from the form of the second DIKP model;

step S313, for the plurality of form items that has been associated with each other in the step S312, traversing the first DIKP model, and finding information associated with the first data according to a mapping relationship thereof; and

step S314, filling the first data into a corresponding form item according to the information associated with the first data.

For example, Tom's data system has three data: DAT (18), DAT (5) and DAT (70), what are the specific meanings of the three data in the case of insufficient, incomplete and inaccurate, all three data can be filled in an age form item, a number form item and other form items in the second DIKP model of the form. For the form item of DAT (age), the first DIKP model of Tom is traversed, and DIKP contents that are possibly related to the age can be found according to the mapping relationship. It is assumed that there is a mapping relationship between a node INF (Tom, just graduates, from a high school) and DAT (18) in the information system, INF (Tom's age, is, 18) can be inferred by combining the three data of DTA (18), DTA (5) and DTA (70) with the form item DAT (age), so that the data DAT (18) can be filled into the form item DAT (age).

Preferably, when the filling value level is determined to be the common level, the fuzzy transmission method is used to fill in the form information, specific steps include: obtaining second data of the preparer in the first DIKP model, and filling the second data into the form by cutting off an inclusion relationship, a cascade relationship, a partial order relationship or a fuzzy change mode among the data, the information and the knowledge.

When filling in the form or the form item with the common level, the preparer can expect that the data, the information and the knowledge to be only partially obtained by the form to satisfy the intention and reduce a disclosure risk thereof, even to some extent, some complete data or information are wanted to be known by the form, so as to want to verify authenticity and the intention of the form, in this case, the flow of data or information from the preparer to the form can be transferred by a fuzzy mode. Combining with the first DIKP model of the preparer, certain changes can be made to the data, the information or the knowledge to improve the probability deviation factor or cut off the inclusion, the cascade or the partial order relationships among the data, the information or the knowledge.

For example, Tom got 96 points in a test, but he didn't want the form to know the specific score. After traversing the form data system, it is found that DAT (96) is the unicom node of DAT (high), in this way, DAT (96) can be transformed into DAT (high) for transmission, which can improve the probability deviation factor, reduce the accuracy and achieve Tom's intention.

The fuzzy transmission can delete key nodes of the contents that have been filled in during the filling process, and destroy past relationships between the data, the information or the knowledge transmission; the present disclosure provides a fuzzy change mode for filling in the form information, the fuzzy change mode includes: transforming a deterministic type to a probabilistic type, transforming an independent type to a comparative type, transforming a global type to a local type, and transforming a numerical type to a range type.

1. Transformation from the Deterministic Type to the Probabilistic Type

The transformation from the deterministic type to the probabilistic type is to express some data or information in the form of probability. For example, INF (Tom is fired by his previous employer) can be transformed into INF (Tom can have voluntarily resigned or been fired). In this case, real resignation information of Tom can't be completely determined during filling in the form item DAT (work experience), which can not only satisfy the intention of the preparer PUP (Tom does not want to let persons know that he is fired), but also give reference information to the form, so as to satisfy the intention of the form to a certain extent, and satisfy filling requirements thereof. Probabilistic data requires the form to infer and determine the content according to the data, the information or the knowledge filled in by the preparer and in combination with its own DIKP system, which can also reduce risks of the data or information disclosure of the preparer.

2. Transformation from the Independent Type to the Comparative Type

The transformation from the independent type to the comparative type is a partial order transformation, which transforms the data or the information that are independently expressed into a comparative form with other data or information. For example, INF (Tom is 170 cm tall) is independent information, which can be transformed into INF (Tom is 5 cm taller than Jerry). Under the condition that the filling value level is the common level, it is difficult to determine what influence the information that has been obtained in the form will have on the preparer, however, if the form has obtained the information INF (Jerry is tall 165 cm) from Jerry, it indicates that the form can be trusted by Jerry, and it can't have a negative influence on Tom after obtaining the information, and then it can be known that Tom's height is 170 cm through Jerry's information, otherwise the information INF (Tom's height is 170 cm) can't be obtained in the form, which achieves a fuzzy transmission effect.

3. Transformation from the Global Type to the Local Type

The transformation from the global type to the local type is a de-completeness process, which indicates that some data or information of the preparer is partially segmented, and a part of contents is provided instead of all the contents. For example, Tom's age is DAT (29), Tom is a woman, and she doesn't want persons to know that she is about to be 30 years old, thereby the data DAT (29) can be transformed into data DAT (2*) to hide the other part of the data DAT (29). For some form intentions, such as PUP (it is to know whether the preparer is an adult), the data DAT (2) can simultaneously satisfy requirements of both, the form and Tom's intention.

4. Transformation from the Numerical Type to the Range Type

The transformation from the numerical type to the range type is to hide some numerical data or information in a certain range, which can be hidden in different ranges according to the intention of the preparer. For example, Tom's weight is 80 kg, his intention is not to let others know that he is so heavy, in this way, numerical data DAT (80 kg) can be transformed into range data DAT (>60 kg) to satisfy Tom's intention. Or Tom is 16 years old and wants to enjoy some minor convenience, such as buying a half-price ticket, but he does not want to disclose accurate age information to strangers, in this way, the data INF(Tom is a minor) and put the age of 16 into the range of minors to satisfy Tom's intention.

Preferably, when the filling value level is determined to be the low level, the defense filling method is used to fill in the form information and includes non-filling and filling in the form by using the fuzzy transmission method.

The step can also be called as a misleading filling step. When the intention of the form or the form item with the low filling value level that has been hidden is difficult to be predicted, it is reasonable to suspect that there are data information security risks for the preparer, so that a defensive filling mode is required. When such above forms are occurred, the forms are not directly filled in under the low filling value level, so as to avoid excessive losses to the preparer; when such a form item is occurred, it is necessary to calculate output and input degrees of nodes of the form item, if the output degree and the input degree are great, even if the form item is not filled in, the form is likely to infer contents of the preparer that have been filled in the form item, according to the contents that have been filled in and the hidden intention of other form items; in this case, it is necessary to perform misleading filling, and then perform fuzzy transmission on the filling contents based on the intention of the form, so as to change the filling contents.

Referring to FIG. 3, the data or the information filled in by the preparer should be verified before the content is filled in. Because the data, the information, the intention, and the knowledge system have certain inclusion, cascade, and partial order relationships, it is easy to violate the intention of another form item node during performing filling on one form item node, and the filled data or information is associated with other form items. Therefore, the step S4 needs to be performed to feedback and verify the form information that has been completely filled in, the specified steps include: step S41, traversing the first DIKP model and the second DIKP model to determine whether the content that has been filled in conforms to the intention of the person that fills in the form; and step S42, when the content that has been filled in does not satisfy the intention of the person that fills in the form, changing the content that does not conform to the intention by means of an intention coverage mode or a fuzzy change mode.

The intention coverage includes performing supplementary coverage mapping on the intention of the preparer, based on the inclusion, the cascade or partial order relationships. If the preparer does not want to let persons know his age, his intention can be supplementarily mapped from the data DAT (age) to the data DAT (birthday) and DAT (ID number) through the cascade or the partial order relationships of data, so as to avoid violating the other intentions of the preparer during filling a certain form item; 2) cutting off the inclusion, the cascade or the partial order relationships, the fuzzy transmission method can be used to blur or change the data or the information to be filled in, so as to cut off the relationships between the data or the information to be filled in; when the preparer does not want to let persons know that his age is DAT (29), the date of birth can be filled in through performing the transformation from the global type to the local type, so as to hide the year of birth, such as DAT (57), or performing other transformations so that it does not violate the intention of the preparer.

The present disclosure combines the DIKP system into automatically filling in the form, and fills in the form information according to the intention of both the preparer and the form, so that the final filled information is driven by the intention of the preparer, which can ensure that the content that has been filled in conforms to the intention of the preparer, so as to achieve intellectualization and rationalization, reduce the tedious manually filling in the form of the preparer, and protect the privacy of the preparer.

The above description is only for a preferred embodiment of the present disclosure and is not intended to limit the present disclosure. Any variation or replacement made by one of ordinary skill in the related art without departing from the spirit of the present disclosure shall fall within the protection scope of the present, disclosure.

What is claimed is:

1. An intention-driven interactive form-filling method for DIKW contents comprising:
step S1, constructing a first DIKP model according to information of a person that fills in a form, and constructing a second DIKP model according to the information of the form;
step S2, performing intention comparison and value determination according to the first DIKP model and the second DIKP model, to obtain a filling value level of the form;
step S3, performing form information filling by using a reducing certainty method, a fuzzy transmission method and a defense filling method, according to different filling value levels; and
step S4, performing feedback verification on the form information that has been completely filled in.

2. The intention-driven interactive form-filling method as claimed in claim 1, wherein the step of constructing the first DIKP model in the step S1, comprises: determining whether a previous DIKP model of the preparer exists in a system, if the previous DIKP model of the preparer does not exist in the system, constructing the first DIKP model according to data and intention currently input by the preparer; if the previous DIKP model of the preparer exists in the system, supplementing and updating the previous DIKP model by using the data and the intention currently input, to obtain the first DIKP model.

3. The intention-driven interactive form-filling method as claimed in claim 1, wherein the second DIKP model in the step S1 is configured to obtain intention of the whole form and each form item according to a form category, an internal form item, a position relationship, a topological structure and alternative items, so as to construct the second DIKP model.

4. The intention-driven interactive form-filling method as claimed in claim 1, wherein specific steps of the step S2 are: comparing the intention of the form and the intention of the preparer, determining a difference between the intention of the form and the intention of the preparer through semantic analysis and DIKP model comparison, determining whether the form that has been filled in generates an income according to the intention of the preparer, and determining a filling value level of the form according to the difference and whether the difference is occurred.

5. The intention-driven interactive form-filling method as claimed in claim 4, wherein the filling value level comprises three levels: a high level, a common level and a low level; if there is a little difference between the intention of the form and the intention of the preparer, and it can be determined that the income is brought to the preparer according to the intention of the preparer, that is, the filling value level is the high level; if there is a little difference between the intention of the form and the intention of the preparer, and it is difficult to determine whether the income is brought to the preparer according to the intention of the preparer, that is, the filling value level is the common level; and if the intention of the four is quite different from the intention of the preparer, that is, the filling value level is the low level.

6. The intention-driven interactive form-filling method as claimed in claim 5, wherein when the filling value level is determined to be the high level, the reducing certainty method is used to fill in the form information, specific steps comprise:
step S311, obtaining first data of the preparer in the first DIKP model;
step S312, obtaining a plurality of form items associated with the first data from the form of the second DIKP model;
step S313, for the plurality of form items that has been associated with each other in the step S312, traversing the first DIKP model, and finding information associated with the first data according to a mapping relationship thereof; and
step S314, filling the first data into a corresponding form item according to the information associated with the first data.

7. The intention-driven interactive form-filling method as claimed in claim 5, wherein when the filling value level is determined to be the common level, the fuzzy transmission method is used to fill in the form information, specific steps comprise: obtaining second data of the preparer in the first DIKP model, and filling the second data into the form by cutting off an inclusion relationship, a cascade relationship, a partial order relationship or a fuzzy change mode among the data, the information and knowledge.

8. The intention-driven interactive form-filling method as claimed in claim 7, wherein the fuzzy change mode comprises: transforming a deterministic type to a probabilistic type, transforming an independent type to a comparative type, transforming a global type to a local type, and transforming a numerical type to a range type.

9. The intention-driven interactive form-filling method as claimed in claim 5, wherein when the filling value level is determined to be the low level, the defense filling method is used to fill in the form information and comprises non-filling and filling in the form by using the fuzzy transmission method.

10. The intention-driven interactive form-filling method as claimed in claim 1, wherein specific steps of the step S4 comprises:
step S41, traversing the first DIKP model and the second DIKP model to determine whether the content that has been filled in conforms to intention of the person that fills in the form; and
step S42, when the content that has been filled in does not satisfy the intention of the person that fills in the form, changing the content that does not conform to the intention by an intention coverage mode or a fuzzy change mode.
